(19) United States
(12) Patent Application Publication
(10) Pub. No.: US 2014/0253051 A1
(43) Pub. Date: Sep. 11, 2014

(54) CHARGING A BATTERY IN A PORTABLE ELECTRONIC DEVICE

(71) Applicant: APPLE INC., Cupertino, CA (US)

(72) Inventors: Yongxuan Hu, Cupertino, CA (US); Mao Ye, San Jose, CA (US); Shimon Elkayam, San Jose, CA (US)

(73) Assignee: APPLE INC., Cupertino, CA (US)

(21) Appl. No.: 13/801,241

(22) Filed: Mar. 13, 2013

Related U.S. Application Data
(60) Provisional application No. 61/773,971, filed on Mar. 7, 2013.

(51) Int. Cl. H02J 7/00

(52) U.S. Cl. CPC H02J 7/007; H02J 7/0072
USPC 320/163; 320/162

(57) ABSTRACT

A system and method are described for charging a battery in a portable electronic device wherein the battery is charged using a constant-current, constant-voltage charging process. In described embodiments, a resistance is received for a current loop that includes a charger and the battery. Then, during a constant-current charging phase, a constant current is output from the charger until an output voltage of the charger reaches a target voltage. The target voltage includes a battery target voltage and a compensation voltage based on the received resistance and a charging current. When the output voltage of the charger reaches the target voltage, the charger switches from the constant-current phase to a constant-voltage phase. Then during the constant-voltage phase, the charger outputs the target voltage until the charging current drops below a minimum value at which time the charging process is complete.

### RELATED APPLICATION

This application claims priority under 35 U.S.C. §119 to U.S. Provisional Application No. 61/773,971, entitled “Charging a Battery in a Portable Electronic Device,” by Yongxuan Hu, Mao Ye and Shimon Elkayam, filed 7 Mar. 2013 (Atty. Docket No.: APL-P17432USP1), the contents of which are herein incorporated by reference in their entirety.

### BACKGROUND

1. Field

The present embodiments relate to systems for charging a battery in a portable electronic device. More specifically, the present embodiments relate to a system that charges a battery in a portable electronic device using a constant-current, constant-voltage charging process.

2. Related Art

A rechargeable battery in a portable electronic device is often charged using a two-phase process in which the battery is first charged at a constant current and then at a constant voltage. During the constant-current charging phase, the charger may output a charging current to the battery at, for example, a 1 C-rate, where the C-rate is the capacity of the battery divided by one hour. When the output voltage of the charger reaches the maximum charging voltage for the battery, the charger then switches to the constant-voltage charging phase. The charger then charges the battery at the maximum charging voltage until the charging current falls to 10% of the 1 C-rate for the battery, at which point the charging process ends. Theoretically, it will take an hour to finish charging a completely discharged battery at 1 C-rate charging. However, the actual charging process may take from 10% to 30% longer than an hour, with the last few percent of battery capacity during the constant-voltage phase taking disproportionately longer than the same increase in battery capacity during the beginning of the constant-current charging phase. Hence, it is desirable to somehow reduce the time required to charge the last few percent of the battery capacity.

### BRIEF DESCRIPTION OF THE FIGURES

FIG. 1 depicts an adapter and a portable electronic device with a charger, a battery, and exemplary resistances and gates in accordance with an embodiment.

FIG. 2 depicts a simplified circuit in the portable electronic device with the charger, the battery, and a current loop resistance that includes an effective resistance and an internal resistance of the battery in accordance with an embodiment.

FIG. 3 depicts a charger in accordance with an embodiment.

FIG. 4 presents a flowchart illustrating a process for charging a battery using a constant-voltage charging phase and a constant-current charging phase in accordance with an embodiment.

FIG. 5 presents a flowchart illustrating a process for determining a target voltage in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The methods and processes described herein can be included in hardware modules or apparatus, including a charger, a system management controller (SMC) and/or a battery management unit (BMU). These modules or apparatus may include, but are not limited to a combination of one or more analog circuits, digital circuits (including integrated circuits which may be or include application-specific integrated circuit (ASIC) chips), field-programmable gate arrays (FPGAs), dedicated or shared processors that execute particular software modules or pieces of code at a particular time, and/or other programmable-logic devices now known or later developed. When the hardware modules or apparatus are activated, they perform the methods and processes included within them. In some embodiments, the hardware modules include one or more general-purpose circuits that are configured by executing instructions (program code, firmware, etc.) to perform the methods and processes.

In the following description, we refer to “some embodiments” and “other embodiments.” Note that “some embodiments” and “other embodiments” each describe a subset of all of the possible embodiments, but do not always specify the same subset of embodiments.

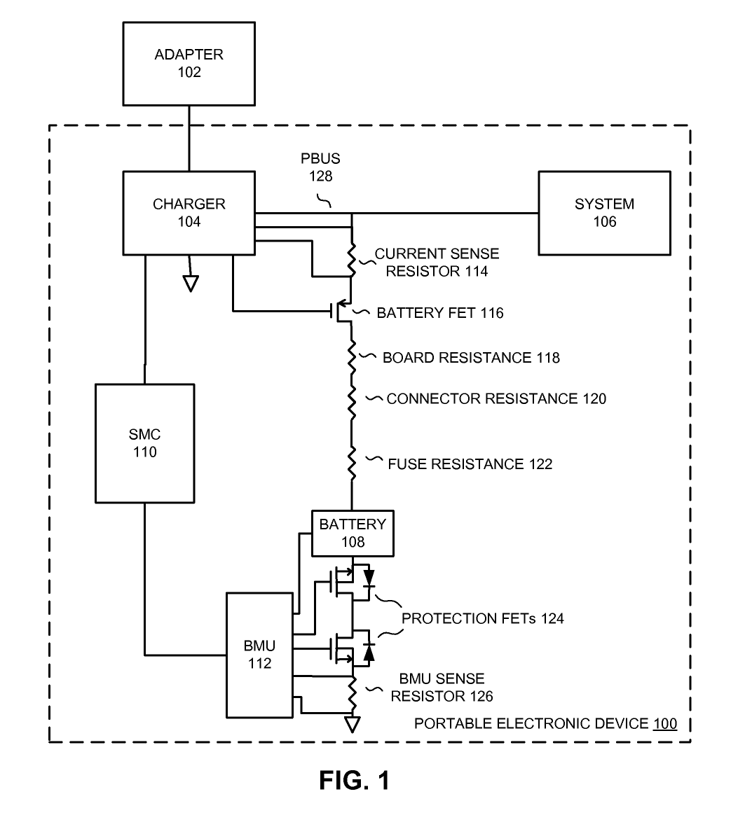

FIG. 1 depicts a portable electronic device that includes a charger, a battery, and exemplary resistances and gates in accordance with an embodiment. Adapter 102 is coupled to charger 104 in portable electronic device 100, and charger 104 is coupled to system 106 through power bus (PBUS) 128. Charger 104 is also coupled to battery 108 through PBUS 128, current sense resistor 114, battery FET 116, board resistance 118, connector resistance 120 and fuse resistance 122. Battery 108 is connected through gates 124 and battery management unit (BMU) sense resistor 126 to ground. BMU 112 is coupled to and controls protection FETs 124, and is also coupled across BMU sense resistor 126. BMU 112 is additionally coupled to and communicates with system management controller (SMC) 110, and SMC 110 is coupled to and communicates with charger 104.

Portable electronic device 100 may be or include, but is not limited to, a smartphone, a tablet computer, a laptop computer, a netbook, or any other portable computing system that includes a charger and a rechargeable battery in accordance with an embodiment.

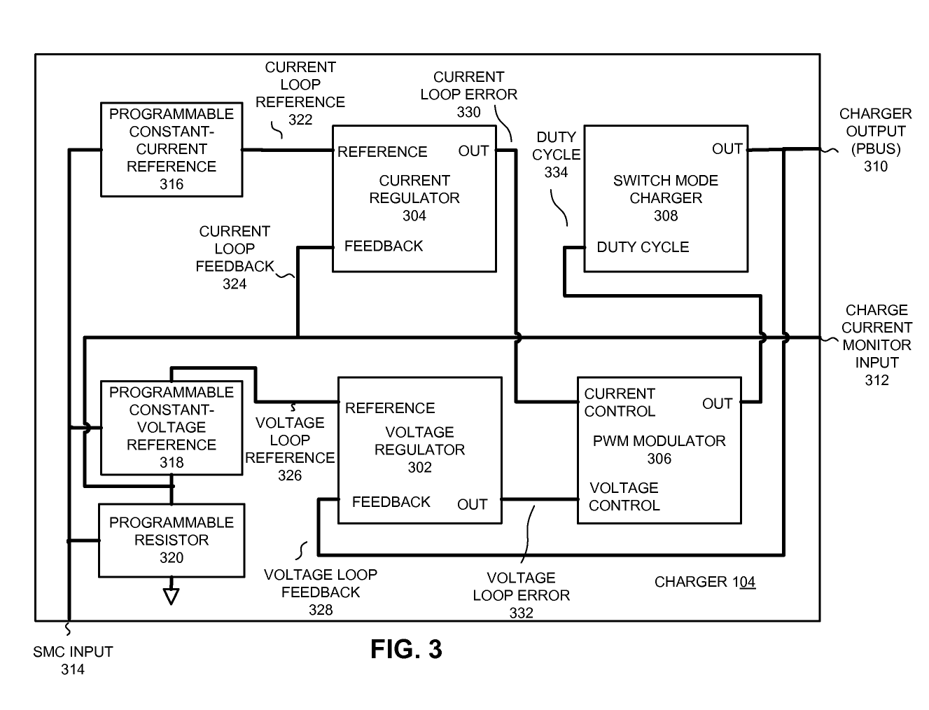

Adapter 102 may be any device that outputs a voltage for use in a charger, and may include, but is not limited to, a wall plug adapter that can be plugged into an AC voltage outlet and outputs a DC voltage (e.g., 5 volts). Charger 104 will be discussed in more detail below with respect to FIG. 3.

System 106 represents all of the other subsystems that may be present in portable electronic device 100 that are not depicted and may include, but is not limited to, one or more processing subsystems (e.g., CPUs), memory subsystems (e.g., volatile and non-volatile), communications subsystems, display subsystems, data collection subsystems, networking subsystems, audio and/or video subsystems, alarm subsystems, media processing subsystems, and/or input/output (I/O) subsystems. Note that one or more of the subsystems in system 106 may be powered by charger 104 and/or battery 108.

Battery 108 may be any rechargeable battery or rechargeable battery system including one or more rechargeable batteries and/or rechargeable battery cells coupled together in any parallel or series configuration to output any desired voltage and/or current. Battery 108 may be implemented in any rechargeable battery chemistry including, but not limited to, nickel metal hydride (NiMH), lithium polymer, and lithium ion battery chemistries.

BMU 112 may be any battery management unit implemented in any technology and may include any combination of hardware and software, and digital and analog circuitry. BMU 112 may include one or more microcontrollers and/or other hardware modules, and may be implemented on one or more integrated circuits. BMU 112 may control current flowing to and from battery 108 using protection FETs 124 and sense current using BMU sense resistor 126. BMU may also determine the state of charge and internal resistance of battery 108. BMU 112 is also coupled to SMC 110 and may communicate information to SMC 110 including the internal resistance of battery 108.

SMC 110 may be any system management controller implemented in any technology and may include any combination of hardware and software, and digital and analog circuitry. SMC 110 may include one or more microcontrollers and/or other hardware modules, and may be implemented on one or more integrated circuits. SMC 110 is coupled to and can communicate with both charger 104 and BMU 112. For example, SMC 110 may be able to receive an internal resistance of battery 108 from BMU 112 and communicate the internal resistance to charger 104, including using the communicated resistance to control a programmable resistor in charger 104 as described below. In some embodiments, SMC 110 may also be coupled to and communicate with system 106.

Current sense resistor 114, battery FET 116, board resistance 118, connector resistance 120, fuse resistance 122, protection FETs 124 and BMU sense resistor 126 represent exemplary resistances and power devices that may be present in portable electronic device 100 in a current loop on which current may flow from charger 104 through battery 108 to ground and back to charger 104. The resistances and power devices represented are meant to be exemplary and in some embodiments there may be different resistances and devices, or more or fewer resistances and devices or components other than those depicted in FIG. 1. Additionally, one or more of the resistances depicted may represent distributed resistances (e.g., the resistance of a circuit board).

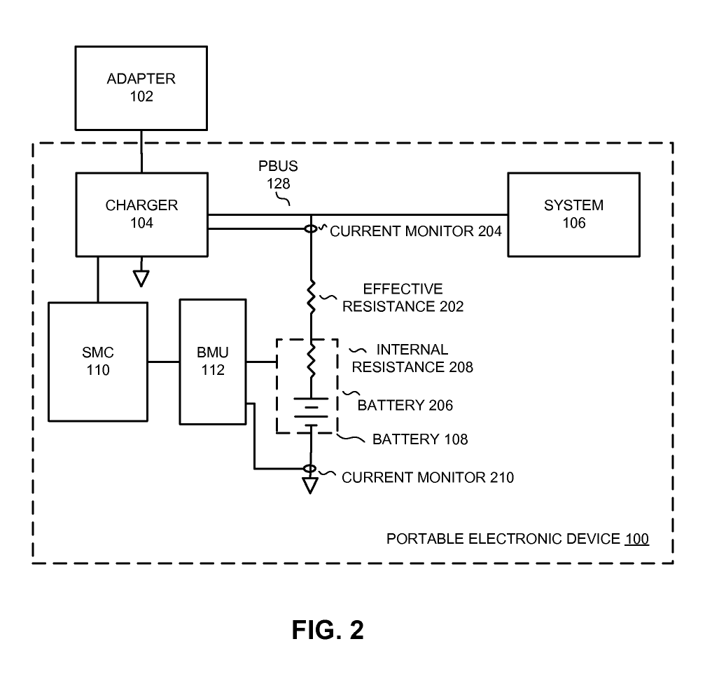

FIG. 2 depicts a simplified circuit including a charger, a battery, an effective resistance, and an internal resistance in accordance with an embodiment. FIG. 2 depicts adapter 102 and portable electronic device 100 with resistances, including resistances due to power devices, lumped together. In FIG. 2, effective resistance 202 represents the resistance of the power devices (e.g., battery FET 116 and protection FETs 124) and other resistances (e.g., current sense resistor 114, board resistance 118, connector resistance 120, fuse resistance 122 and BMU sense resistor 126) in the current loop that includes charger 104 and battery 108. Effective resistance 202 may be determined based on the design of portable electronic device 100. In some embodiments, effective resistance 202 may be measured or determined during the manufacture of portable electronic device 100 or during testing prior to its sale.

Current monitor 204 represents an idealized current monitor (e.g., no resistance) that is used by charger 104 to monitor the charging current flowing to battery 108. Current monitor 210 also represents an idealized current monitor (e.g., no resistance) that is used by BMU 112 to monitor current flowing to and from battery 108.

Battery 108 is depicted including idealized battery 206 which includes no internal resistance in series with internal resistance 208 which represents the internal resistance of battery 108. BMU 112 may monitor battery 108 to determine internal resistance 208. Note that the total resistance in the current loop that includes charger 104 and battery 108 is then the sum of effective resistance 202 and internal resistance 208.

FIG. 3 depicts a charger in accordance with an embodiment. Charger 104 includes voltage regulator 302 and current regulator 304, each with its output coupled to pulse width modulation (PWM) modulator 306. PWM modulator 306 is coupled to switch mode charger 308. The output of the switch mode charger is then coupled to the charger output PBUS 310. Charge current monitor input 312 is coupled to both programmable resistor 320 and current loop feedback 324 of current regulator 304. Programmable resistor 320 is coupled through programmable constant-voltage reference 318 to voltage loop reference 326 of voltage regulator 302. This is the reference of the constant-voltage regulation. Charger output PBUS 310 is coupled to the voltage loop feedback 328 of voltage regulator 302. Programmable constant-current reference 316 is coupled to current loop reference 322 of current regulator 304. SMC input 314 is coupled to and controls programmable resistor 320, programmable constant-voltage reference 318, and programmable constant-current reference 316.

Voltage regulator 302 may be any differential amplifier that can output a voltage loop error 332 set by the difference between the voltage loop reference 326 and voltage loop feedback 328. Voltage regulator 302 may be implemented in any technology and may be a combination of analog and digital circuits and/or elements implemented using any combination of discrete and integrated circuits and components. In some embodiments, voltage regulator 302 may receive input (e.g., from current monitor 204) through charge current monitor input 312 and may be configured to stop outputting current when the charging current input on charge current monitor input 312 reaches a predetermined value (e.g., 10% of the 1 C-rate for the battery being charged). Note that the predetermined value may be set using any desired method including, but not limited to, a value based on information communicated from battery 108 through BMU 112 to SMC 110 to charger 104 and then to voltage regulator 302.

Current regulator 304 may be any current regulator that can output a current loop error 330 set by the difference between the current loop reference 322 and current loop feedback 324. Current regulator 304 may be implemented in any technology and may be a combination of analog and digital circuits and/or elements implemented using any combination of discrete and integrated circuits and components. In some embodiments, current regulator 304 may include a current source (not shown) used to determine the current set-point for the output of current regulator 304. Current regulator 304 may also use feedback from a current monitor (e.g., current monitor 204) through charge current monitor input 312 to control its output current.

PWM modulator 306 may employ any type of PWM scheme that can output a duty cycle 334 to a switch mode charger 308 in any technology. The duty cycle may be controlled in a closed-loop manner depending which loop error signal is smaller (e.g., PWM modulator may determine the duty cycle based on current loop error signal 330 if current loop error signal 330 is smaller than voltage loop error 332). During a constant-current charging phase, current loop reference 322 is very close to current feedback 324 and thus the current loop error signal 330 is smaller compared to voltage loop error 332. PWM modulator may select current loop error signal 330 to determine the duty cycle 334. As the battery voltage goes up during charging, voltage loop feedback 328 may go up to be close to voltage loop reference 326. When this happens, the voltage loop error signal 332 from voltage regulator 302 may drop below current loop error signal 330. PWM modulator 306 may select voltage loop error 332. This is the transition from the constant-current charging phase to the constant-voltage charging phase. PWM modulator 306 may be implemented in any technology and may be a combination of analog and digital circuits and/or elements implemented using any combination of discrete and integrated circuits and components.

Switch mode charger 308 may employ any type of switch mode converter (e.g., buck, boost, buck-boost, SEPIC, Cuk, etc.) that can convert power from adapter 102 output to charger output 128 efficiently in a switching manner.

Programmable constant-current reference 316 may be any type of current reference implemented in any technology. In some embodiments, the current through programmable constant-current reference 316 is set equal to the maximum allowable charging current (e.g., 1 C-rate for certain lithium ion rechargeable batteries). In some embodiments, the current through programmable constant-current reference 316 may be determined when charger 104 is manufactured, while in other embodiments, the current through programmable constant-current reference 316 may be set or programmed using SMC 110 through the connection to SMC input 314.

Programmable constant-voltage reference 318 may be any type of voltage reference implemented in any technology. In some embodiments, the voltage across programmable constant-voltage reference 318 is set equal to the maximum allowable charging voltage (e.g., 4.2 V per cell for certain lithium ion rechargeable batteries). In some embodiments, the voltage across programmable constant-voltage reference 318 may be determined when charger 104 is manufactured, while in other embodiments, the voltage across programmable constant-voltage reference 318 may be set or programmed using SMC 110 through the connection to SMC input 314.

Programmable resistor 320 may be any type of programmable resistor implemented in any technology. Programmable resistor 320 receives input from SMC 110 through SMC input 314 to set the resistance of programmable resistor 320. Although programmable resistor 320 is depicted as being an internal subsystem of charger 104, in some embodiments programmable resistor 320 may be external to charger 104. Additionally, in some embodiments, programmable resistor 320 may include fixed resistance portions (e.g., representing effective resistance 202) or may be comprised of two or more programmable resistors, each separately programmable through SMC input 314. During operation of charger 104, a signal representing the charge current enters charger 104 through charge current monitor input 312 and flows through programmable resistor 320 to ground. The voltage across programmable resistor 320 is then added to the voltage across voltage reference 318 and used as voltage loop reference input 326 to voltage regulator 302 as described above. Note that, in some embodiments, the resistance of programmable resistor 320 and the current input through charge current monitor input 312 may be scaled in opposite directions by a convenient factor as long as their product (i.e., the voltage across programmable resistor 320) is unchanged (e.g., represents the voltage drop of the charging current into battery 206 across the resistance for the current loop which is comprised of effective resistance 202 and internal resistance 208).

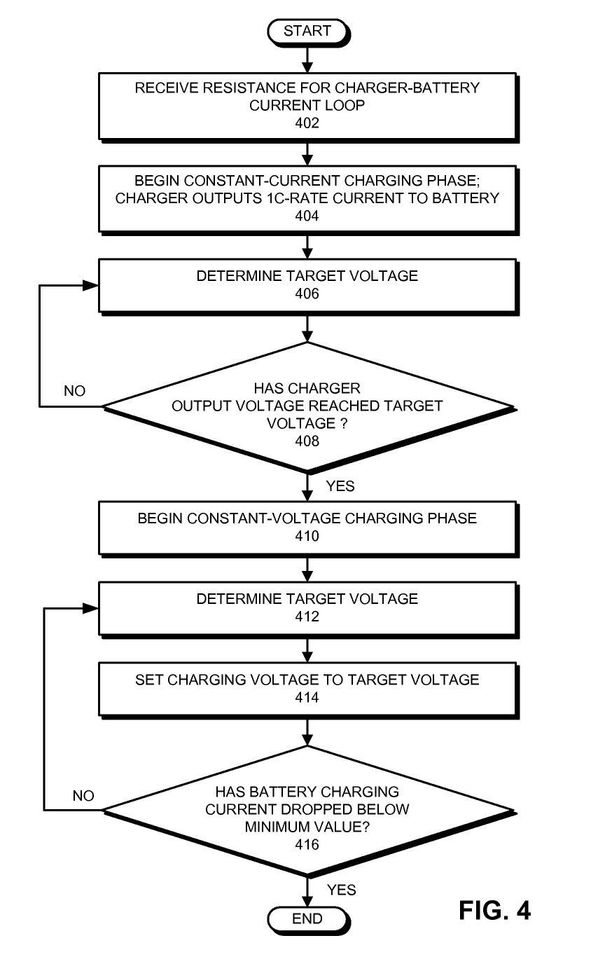

FIG. 4 presents a flowchart illustrating a process for charging a battery using a constant-voltage charging phase and a constant-current charging phase in accordance with described embodiments. The operations shown in FIG. 4 may be performed by a portable electronic device, such as portable electronic device 100.

The process of FIG. 4 may begin when charger 104 and/or SMC 110 receive a resistance for the current loop that includes charger 104 and battery 108 (step 402). This received resistance may include effective resistance 202, which may be determined based on the design of one or more components in the current loop (and represented by effective resistance 202), and may also include internal resistance 208 determined by BMU 112. Note that effective resistance 202 may be received by charger 104 and/or SMC when portable electronic device 100 is manufactured or during testing prior to sale, and internal resistance 208 may be received by SMC 110 after its determination by BMU 112.

Then, at step 404, charger 104 begins the constant-current charging phase and outputs, for example, a 1 C-rate charging current to battery 108. Note that charger 104 may monitor the charging current flowing to battery 108 using current monitor 204 which inputs the current reading through charge current monitor input 312 to current regulator 304. In some embodiments, a charging current rate other than a 1 C-rate may be used.

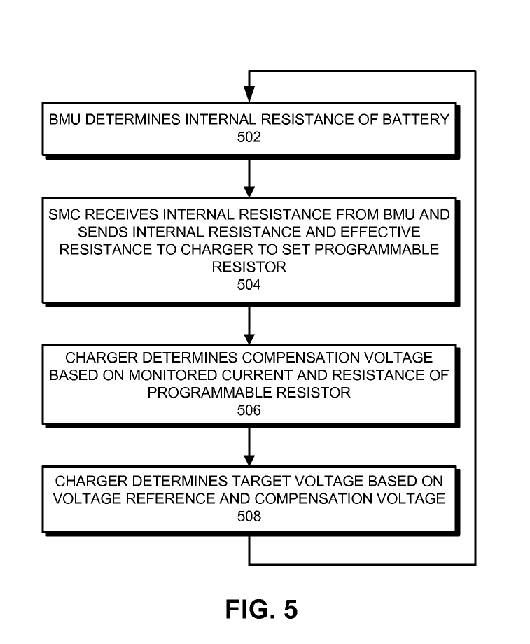

At step 406, the target voltage is determined. FIG. 5 presents a flowchart illustrating a process for determining the target voltage in accordance with described embodiments. The operations shown in FIG. 5 may be performed by a portable electronic device, such as portable electronic device 100. At step 502, BMU 112 determines internal resistance (e.g., internal resistance 208) of battery 108. Note that BMU 112 may use any process to determine the internal resistance 208 of battery 108. BMU 112 sends the internal resistance to SMC 110 and SMC 110 sends the internal resistance and effective resistance to charger 104 and, through SMC input 314, sets the resistance of programmable resistor 320 to the resistance of the current loop based on internal resistance 208 and effective resistance 202 (step 504). Note that, in some embodiments, SMC 110 may set the resistance of programmable resistor 320 based solely on effective resistance 202 or solely on internal resistance 208 or on a combination of both resistances. SMC 110 may further use known or approximated errors in the determinations of these resistances when setting programmable resistor 320. For example, SMC 110 may set programmable resistor 320 to a resistance based on the combination of effective resistance 202 and internal resistance 208 and subtract a maximum error in the determination of each resistance value, or use a minimum design resistance for one or both values

At step 506, charger 104 then determines the compensation voltage based on programmable resistor 320 and the current monitored using current monitor 204 and input into adapter 104 through charge current monitor input 312. Then, at step 508, charger 104 determines the target voltage based on the voltage across voltage reference 318 and the compensation voltage (e.g., the voltage generated by the monitored current input into charge current monitor input 312 across programmable resistor 320 to ground). The target voltage is output from voltage reference 318 to voltage regulator 302.

Returning to FIG. 4, when the target voltage has been determined, then at step 408, if the output voltage of switch mode charger 308 of charger 104 has not reached the target voltage, then the process returns to step 406, while if the output voltage of charger 104 has reached the target voltage, then the process continues to step 410.

At step 410, the constant-current charging phase ends and current regulator 304 stops outputting charging current. Then, the constant-voltage charging phase begins with voltage regulator 302 outputting a constant voltage charging current through charger output 306 to battery 108. At step 412, the target voltage is determined as described above with reference to FIG. 5. At step 414, the target voltage input is used by voltage regulator 302 to set its voltage output. Then, at step 416, if the charging current has not dropped below a minimum value, the process returns to step 412. If the charging current has dropped below the minimum value, then the constant-current charging phase ends and voltage regulator 302 stops outputting a charging current. Note that the minimum value for the charging current may be set to a percentage of the C-rate for battery 108, such as 10%, or any other current value desired for the termination of the constant-voltage charging phase.

Note that, in some embodiments, step 402 and the constant-current charging phase described above with reference to FIG. 4 may be used alone (e.g., steps 402 to 408) and not followed by the constant-voltage charging phase as described above. Additionally, in some embodiments, step 402 and the constant-voltage charging phase described above with reference to FIG. 4 (e.g., step 402 and steps 410 to 416) may be used without being preceded by the constant-current charging phase as described above.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for charging a battery in a portable electronic device, wherein the battery is charged using a constant-current, constant-voltage charging process, the method comprising:
receiving a resistance for a current loop that includes a charger and the battery;
during a constant-current charging phase, outputting a constant current from the charger until an output voltage of the charger reaches a target voltage, wherein the target voltage includes a battery target voltage and a compensation voltage, wherein the compensation voltage is based on the received resistance and a charging current;
switching from the constant-current charging phase to a constant-voltage charging phase when the output voltage reaches the target voltage; and
during the constant-voltage charging phase, outputting the target voltage, which includes the battery target voltage and the compensation voltage, from the charger until the charging current drops below a minimum value at which time the charging process is complete.

2. The method of claim 1, further including:
monitoring the charging current entering the battery, wherein the monitored charging current is used to determine the charging current and the compensation voltage.

3. The method of claim 2, wherein:
outputting the target voltage includes using the determined charging current in a feedback loop to control the target voltage.

4. The method of claim 1, wherein:
receiving the resistance for the current loop includes receiving an internal resistance of the battery.

5. The method of claim 4, further including:
determining the internal resistance of the battery using a battery management unit (BMU), wherein receiving the internal resistance includes receiving the determined internal resistance, and wherein outputting the target voltage includes communicating the internal resistance from the BMU to a system management controller (SMC) for use in a feedback loop to control the target voltage.

6. The method of claim 1, wherein outputting the target voltage includes setting a programmable resistor for a voltage regulator based on an internal resistance of the battery.

7. The method of claim 1, wherein:
the received resistance for the current loop is based on a design resistance for the current loop.

8. The method of claim 1, wherein during the constant-current phase, outputting the constant current from the charger until the output voltage of the charger reaches the target voltage includes communicating an internal resistance of the battery from a battery management unit (BMU) to a system management controller (SMC) for use in a feedback loop to set the target voltage, and further including:
determining the internal resistance of the battery using the BMU, wherein receiving the resistance for the current loop includes receiving the internal resistance of the battery determined using the BMU.

9. A system for charging a battery in an electronic device, comprising:
a battery;
a current regulator coupled to the battery;
a voltage regulator coupled to the battery, wherein a voltage set-point circuit of the voltage regulator includes a compensation resistor; and
a current monitor coupled to a current loop through the voltage regulator and the battery and configured to monitor a charging current entering the battery, wherein feedback from the current monitor is coupled to the compensation resistor.

10. The system of claim 9, wherein the compensation resistor includes a programmable resistor, and the system further includes:
a system management controller (SMC), wherein the SMC is configured to set the programmable resistor based on a resistance for the current loop.

11. The system of claim 9, wherein the compensation resistor includes a programmable resistor, and the system further includes:
a battery management unit (BMU) configured to determine an internal resistance of the battery; and
a system management controller (SMC), wherein the SMC is configured to receive information from the BMU related to the internal resistance of the battery and set the programmable resistor based on the received information.

12. The system of claim 9, wherein the current regulator is configured to output a charging current during a constant-current charging phase until the charging current reaches a target voltage, wherein the target voltage is determined based on a battery target voltage and a compensation voltage.

13. The system of claim 12, wherein the current regulator is configured to determine the compensation voltage based on the charging current during the constant-current charging phase and a resistance, wherein the resistance is based on a resistance for a current loop connecting the current regulator and the battery.

14. A method for charging a battery in a portable electronic device, wherein the battery is charged using a constant-current charging, constant-voltage charging process, the method comprising:
during a constant-current charging phase, outputting a constant current from the charger with a target voltage determined based on a battery target voltage and a compensation voltage;
when a voltage from the charger during the constant current phase reaches the target voltage, switching to a constant-voltage charging phase; and
during the constant-voltage charging phase, using a feedback loop to control a voltage of a charging current output from the charger to a set-point based on a voltage across the battery.

15. The method of claim 14, wherein:
using the feedback loop to control the voltage includes monitoring the charging current; and
the set-point is determined based on a battery target voltage and a voltage drop for a current loop through the charger and the battery.

16. The method of claim 15, further including:
determining the voltage drop, wherein the voltage drop includes receiving a resistance for the current loop, wherein the resistance is based on a design resistance for the current loop.

17. The method of claim 15, further including:
determining the voltage drop, wherein determining the voltage drop includes receiving a resistance for the current loop, wherein receiving the resistance for the current loop includes receiving an internal resistance of the battery determined using a battery management unit (BMU).

18. The method of claim 17, wherein:
using the feedback loop to control the voltage includes communicating information related to the internal resistance of the battery from the BMU to a system management controller (SMC) for use in controlling the voltage.

19. The method of claim 18, wherein the SMC uses the information related to the internal resistance of the battery to control a programmable resistor, wherein the programmable resistor is used to determine the voltage.

20. The method of claim 19, wherein:
the SMC controls the programmable resistor based on the information related to the internal resistance of the battery and a design resistance for the current loop.
